(19) United States
(12) Patent Application Publication
(10) Pub. No.: US 2010/0011146 A1
(43) Pub. Date: Jan. 14, 2010

(54) Conveying Information With a PCI Express Tag Field

(75) Inventor: Eugene Saghi, Colorado Springs, CO (US)

Correspondence Address: LNG/LSI JOINT CUSTOMER;C/O LUEDEKA, NEELY & GRAHAM, P.C., P.O. BOX 1871, KNOXVILLE, TN, 37901, US

(73) Assignee: LSI CORPORATION, Milpitas, CA (US)

(21) Appl. No.: 12/171,383

(22) Filed: Jul. 11, 2008

(51) Int. Cl. G06F 13/36

(52) U.S. Cl. 710/314

(57) ABSTRACT

A method for determining when all data has been sent for a given PCI Express bus command issued by a backend entity of a PCI Express bus device, by setting a PCI Express bus packet header tag field of a PCI Express bus packet to indicate a backend entity that originated the PCI Express bus command and whether the PCI Express bus packet is a last packet of the PCI Express bus command, and then inspecting the PCI Express bus packet header tag field of the PCI Express bus packet to determine whether the PCI Express bus packet is the last packet of the PCI Express bus command.

### FIELD

This invention relates to the field of computing. More particularly, this invention relates to PCI Express bus communications.

### BACKGROUND

PCI Express bus devices typically implement multiple functions. These functions generally operate independently one from another. Even in single-function devices, there may be many backend entities that share one PCI Express function. When troubleshooting PCI Express systems, it is often very difficult or impossible to correlate a PCI memory write packet back to the function or backend entity that issued the write request. This is because the only identifying information in the packet is the destination address. Thus, unless the destination addresses of the memory write packet is unique to the originating function or backend entity, there are no known solutions for finding the sending entity.

What is needed, therefore, is a system that overcomes limitations such as those described above, at least in part.

### SUMMARY

The above and other needs are met by a method for determining when all data has been sent for a given PCI Express bus command issued by a backend entity of a PCI Express bus device, by setting a PCI Express bus packet header tag field of a PCI Express bus packet to indicate a backend entity that originated the PCI Express bus command and whether the PCI Express bus packet is a last packet of the PCI Express bus command, and then inspecting the PCI Express bus packet header tag field of the PCI Express bus packet to determine whether the PCI Express bus packet is the last packet of the PCI Express bus command.

In this manner, the device inspecting the header tag field, which is otherwise unused in a PCI Express bus packet, can determine which backend device has originated the packet, and whether the packet comprises the final portion of the command.

In various embodiments, the backend entity sets the PCI Express bus packet header tag field. At least one of a PCI Express bus core or a bus analyzer inspects the PCI Express bus packet header tag field in some embodiments.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a prior art depiction of the format of a PCI Express memory write packet.

FIG. 2 is block diagram of PCI Express device according to an embodiment of the present invention.

### DETAILED DESCRIPTION

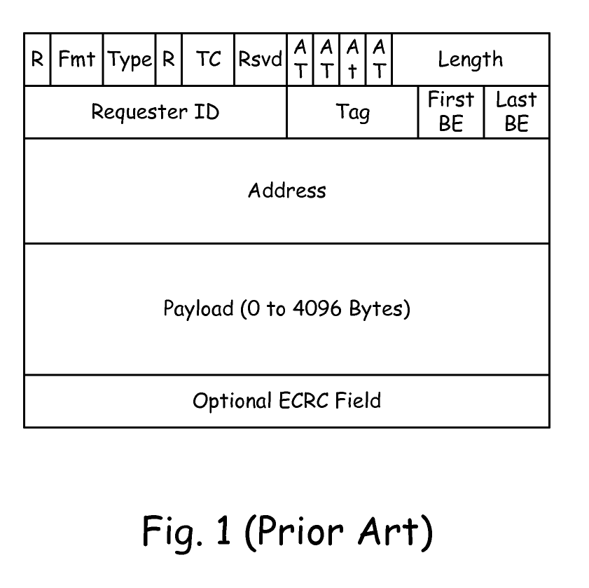

With reference now to FIG. 1, there is depicted the prior art representation of the format of a PCI Express memory write request packet. The PCI Express Base Specification Revision 2.0 states that the eight bit Tag field of the memory write request packet is undefined and may contain any value. PCI Express devices typically set this field to zero. The various embodiments of the present invention make use of this undefined Tag field to convey useful information.

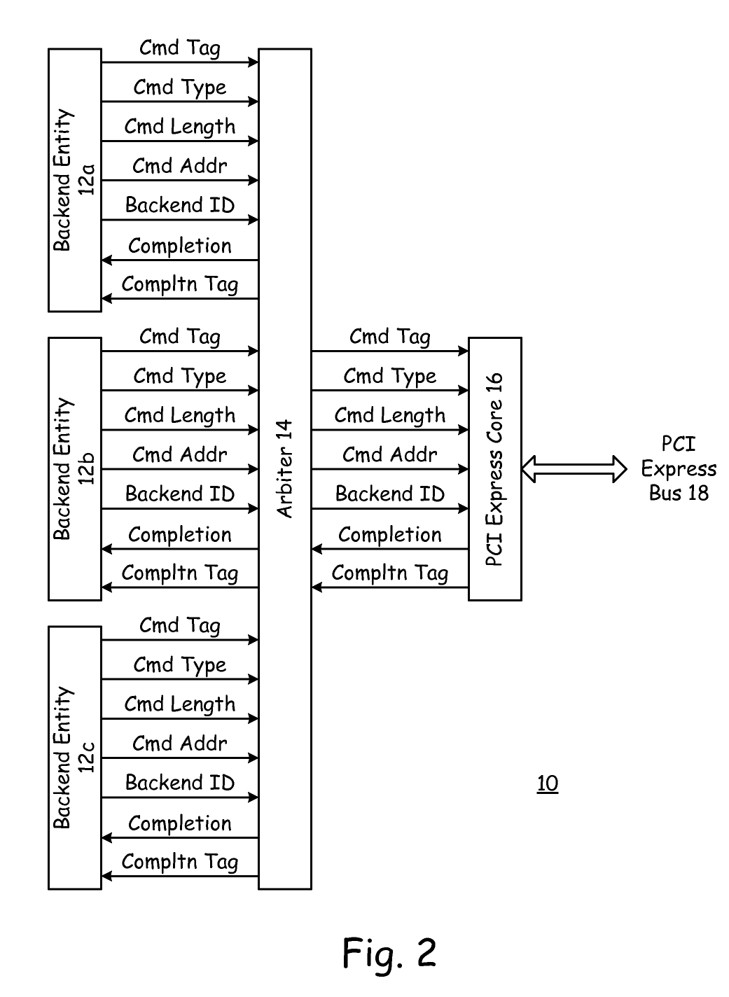

With reference now to FIG. 2, there is depicted a typical PCI Express device 10 with multiple backend entities 12. The backend entities 12 send commands to the PCI Express core 16 through an arbiter 14. Each backend entity 12 can issue multiple commands to the PCI Express core 16. The backend entities 12 each specify a command tag, command type, command length, command address, and backend identification. The command length may be much larger than the maximum PCI Express payload size or read request size. The PCI Express core 16 breaks the command into multiple PCI Express request packets when this is the case.

The command tag is not related to the tag field in the PCI Express packet header, as depicted in FIG. 1. When the PCI Express core 16 completes a command, it indicates this fact by returning the command tag (labeled as Compltn Tag in FIG. 2) and a finished flag (labeled as Completion in FIG. 2) to the backend entity 12 that originated the command.

The various embodiments of the present invention allow the PCI Express packet header tag field of the memory write packets to be set to any of three values given below, depending on a register controlled by firmware:

{Last packet for command, Backend ID},

### {CmdTag}, and

{Last packet for command, least significant 3 bits of CmdTag, Backend ID (4 bits)}

The indication of the last packet for a command is very useful for determining when all of the data for a command issued by a backend entity 12 has been sent.

Application of the embodiments of the present invention makes it possible to correlate PCI Express memory write packets back to the backend entity 12 and the IO command issued by that entity 12. This is very useful for troubleshooting a live system, or for scoreboarding in a simulation environment. Scoreboarding is the automated checking of data moved from one place to another in the device under test.

Simulation environment scoreboarding is greatly simplified be providing a means for determining the backend entity 12 or the command tag for a received PCI Express memory write packet, simply by examining the tag specified in the header for that packet.

In a live system, the PCI Express memory write packet tag field for a given packet is easily captured with a bus analyzer. Using various embodiments of the invention described here, the tag is correlated back to the command or event in the issuing device to allow for troubleshooting possible issues in a straight-forward manner.

There are several methods backend entities 12 use to generate command tags. One method is to map a tag to a backend function. For example, if a backend entity 12 has three DMA engines, it can assign tags 0, 1, and 2 to those DMA engines. Any time DMA engine 1 issues a command, the tag for that command is 1. Another method for generating command tags is through the use of a counter. The first tag issued is 0, then 1, and so on. The counter rolls over (goes back to 0), once the count has exceeded the maximum number of simultaneous commands the backend entity can issue. Other methods for generating command tags are also possible.

In one embodiment, the backend entities 12 do not coordinate with one another in the generation of tags. However, each backend entity 12 has a unique ID. Thus, the combination of backend ID and command tag is unique.

A bus analyzer can monitor the PCIe bus in a live system. Using a PCIe bus analyzer, all the details of the packets on the PCIe bus can be seen. Thus, the embodiments of the invention as described herein are very useful in a live system. Currently, the tags issued with PCIe memory write commands are all set to zero. There is no way to tell which backend entity 12 actually originated the write command. In a device with multiple backend entities 12 (some devices have sixteen or more such entities 12), knowing which entity 12 originated the command along with other information contained in a packet is enough information to troubleshoot some problem in the device 10.

Consider the example of a device 10 that has sixteen backend entities 12, where each entity 12 has resources sufficient to issue up to eight simultaneously outstanding commands. One could then concatenate the Backend ID and the Command Tag and the indication of the last packet for the command to form the header tag that is sent out with each memory write packet. Consider when the backend ID 2 issues a memory write command with command tag 5, and the backend ID 4 issues a memory write command with command tag 7, and each command requires 4 PCIe packets to be sent. Using a PCIe bus analyzer, one could track the activity on the PCIe bus by looking at the tags issued in the packets. For example, one might see the following sequence of tags:

0, 2, 5 (not the last packet, backend ID 2, command tag 5)

0, 4, 7 (not the last packet, backend ID 4, command tag 7)

0, 4, 7 (not the last packet, backend ID 4, command tag 7)

0, 2, 5 (not the last packet, backend ID 2, command tag 5)

0, 2, 5 (not the last packet, backend ID 2, command tag 5)

1, 2, 5 (last packet, backend ID 2, command tag 5)

0, 4, 7 (not the last packet, backend ID 4, command tag 7)

1, 4, 7 (last packet, backend ID 4, command tag 7)

A non-test environment embodiment of the present invention is also possible, where the devices at both ends of the bus understand that the issued PCIe tags carry information. In most devices, the PCIe tag for received memory write packets is ignored and thrown away. However, a device that is designed to expect encoded tags would be able to benefit from this embodiment. In live PCI Express systems, there is no known alternative to correlate a memory write packet received at one end of the PCI Express bus back to the backend entity 12 that caused the packet to be issued at the other end of the PCI Express bus.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for determining when all data has been sent for a given PCI Express bus command issued by a backend entity of a PCI Express bus device, the method comprising the steps of:
setting a PCI Express bus packet header tag field of a PCI Express bus packet to indicate a backend entity that originated the PCI Express bus command and whether the PCI Express bus packet is a last packet of the PCI Express bus command, and
inspecting the PCI Express bus packet header tag field of the PCI Express bus packet to determine whether the PCI Express bus packet is the last packet of the PCI Express bus command.

2. The method of claim 1, wherein the backend entity sets the PCI Express bus packet header tag field.

3. The method of claim 1, wherein a PCI Express bus core inspects the PCI Express bus packet header tag field.

4. The method of claim 1, wherein a bus analyzer inspects the PCI Express bus packet header tag field.

5. A method for determining when all data has been sent for a given PCI Express bus command issued by a backend entity of a PCI Express bus device, the method comprising the steps of:
setting a PCI Express bus packet header tag field of a PCI Express bus packet to indicate whether the PCI Express bus packet is a last packet of the PCI Express bus command, and
inspecting the PCI Express bus packet header tag field of the PCI Express bus packet to determine whether the PCI Express bus packet is the last packet of the PCI Express bus command.

6. The method of claim 5, wherein the backend entity sending the PCI Express bus packet sets the PCI Express bus packet header tag field.

7. The method of claim 5, wherein the PCI Express bus packet header tag field is also set to indicate the backend entity sending the PCI Express bus command.

8. The method of claim 5, wherein a PCI Express bus core inspects the PCI Express bus packet header tag field.

9. The method of claim 5, wherein a bus analyzer inspects the PCI Express bus packet header tag field.

10. The method of claim 5, wherein the PCI Express bus command is a memory write command and the PCI Express bus packet is a PCI Express bus memory write packet.

11. A method for determining which backend entity of a PCI Express bus device originated a PCI Express bus command, the method comprising the steps of:
setting a PCI Express bus packet header tag field of a PCI Express bus packet to indicate the backend entity that originated the PCI Express bus command, and
inspecting the PCI Express bus packet header tag field of the PCI Express bus packet to determine which backend entity originated the PCI Express bus command.

12. The method of claim 11, wherein the backend entity sets the PCI Express bus packet header tag field.

13. The method of claim 11, wherein a PCI Express bus core inspects the PCI Express bus packet header tag field.

14. The method of claim 11, wherein a bus analyzer inspects the PCI Express bus packet header tag field.

15. The method of claim 11, further comprising setting the PCI Express bus packet header tag field to indicate whether the PCI Express bus packet is a last packet of the PCI Express bus command.
